(19) United States
(12) Patent Application Publication
(10) Pub. No.: US 2006/0229887 A1
(43) Pub. Date: Oct. 12, 2006

(54) Warehouse management system

(75) Inventors: Oing-Lin Liang, Taipei (TW); Chia-Chun Lee, Taipei (TW); Jeff Song, Taipei (TW); Win-Harn Liu, Taipei (TW)

Correspondence Address: PEARL COHEN ZEDEK, LLP, 1500 BROADWAY 12TH FLOOR, NEW YORK, NY, 10036, US

(73) Assignee: INVENTEC CORPORATION

(21) Appl. No.: 11/092,915

(22) Filed: Mar. 30, 2005

(51) Int. Cl. G06Q 99/00

(52) U.S. Cl. 705/1

(57) ABSTRACT

A warehouse management system is applied under a network environment to integrate warehouses of suppliers and retailers in the network environment and provide an information communication channel between the suppliers and retailers. The warehouse management system includes a logic management module for allowing the suppliers and retailers to enter information; a data storage module for storing the information; an information management module for synchronously updating the information to the data storage module; and an information display module for synchronously displaying the information on data processing devices. By the warehouse management system, integration of warehouse management can be achieved, such that management efficiency and economic benefits are enhanced.

### FIELD OF THE INVENTION

The present invention relates to warehouse management technologies, and more particularly, to a warehouse management system applied between suppliers and retailers under a networking environment.

### BACKGROUND OF THE INVENTION

General warehouses can be divided into several categories according to uses thereof, including one in companies for storing goods of daily sales; one in factories for storing stock materials and manufactured products for retailing; one referring to a large warehouse for temporary storage of import/export goods for inspection in airports and the Customs; and one referring to a specialized warehouse usually in an industrial or factory area for use with companies nearby.

In the costs for a business, the material cost usually takes above 50%, and warehouse management has enormous impact on the costs. If the warehouse management is not proper, profits would become useless waste materials in the warehouse; or if backup support is not sufficient enough, the business would become outdated due to competition. Thus, materials represent money, and the warehouse represents money storage, such that the warehouse management is considered critically important.

In the past, warehouse facilities were simple, and materials were simply categorized and stored in the warehouse or on shelves and can be retrieved upon demand. Nowadays, along with the development of international trade and the growth in size of manufacturers, the quantities and variation of types of incoming and output goods and materials are also increased. Many businesses have built large and automated warehouses with heavy costs so as to adjust supply of raw materials and market fluctuation and prevent excess stocks that may hold up capital and affect company operation as well as avoid lack of raw materials on the production line, which may affect product output if being short of material stocks. Therefore, warehouse management is a very important task nowadays. Duties of a traditional warehouse manager include: (1) checking if arriving materials and goods are consistent with order request forms, receipts and other documents; (2) inspecting whether the arriving materials and goods are damaged and if they comply to correct specification, if any of the materials and goods is damaged or not correct in specification, removing it from the stock, returning it to its shipping unit and ordering an replacement to be delivered in a specified period; (3) recording incoming and output materials and goods on cards or material books according to their categories; (4) deciding if the materials or goods should be stored in predetermined positions with specific facilities according to their material properties, and making necessary marks and descriptions for these specifically stored materials or goods; (5) after delivery of goods, applying for materials in need to maintain the stock level according to regulations or self experience; and (6) running regular stocktaking to ensure the stocks complying with the records, and making notes for reporting.

Thus, the duties of the warehouse manager appear to be simple, but they are considered as an essential and important step in the overall trading activity. The procedures such as stocktaking, receiving, delivery and management of incoming and output goods must be planned in details and handled appropriately such that the trading activity can run smoothly.

However, along with the growth of computer and network technologies, the mode of warehouse management has changed over the time. The traditional mode of warehouse management is individual management, that is, the business only manages its own warehouses by warehouse managers. Even if the business builds a network warehouse management system, such system is only for internal use but not connected to other businesses through a network. This limits the application scope of warehouse management and subsequently affects revenue returns for the business. And most of the warehouses are only used for storing goods and performing simple search and stocktaking on the goods, and are not efficiently managed.

Therefore, the problem to be solved here is to integrate warehouse management systems of related businesses and achieve information communication between the related businesses.

### SUMMARY OF THE INVENTION

In light of the drawbacks in the prior art, a primary objective of the present invention is to provide a warehouse management system, which can integrate warehouses of suppliers and retailers to achieve synchronous information communication between the suppliers and retailers.

Another objective of the present invention is to provide a warehouse management system so as to more efficiently manage warehouses and enhance economic benefits.

In order to achieve the above and other objectives, the present invention proposes a warehouse management system, which includes a logic management module for allowing suppliers and retailers to enter information; a data storage module for storing the information; an information management module for synchronously updating the information to the data storage module; and an information display module for synchronously displaying first and second management interfaces and the information on data processing devices.

Unlike the conventional individual warehouse management system, the present invention uses the logic management module for allowing suppliers and retailers to enter information, and uses the information display module to synchronously display the information at the suppliers and retailers, such that the foregoing objectives such as synchronous communication between the suppliers and retailers, efficient warehouse management and enhanced economic benefits can be achieved.

### BRIEF DESCRIPTION OF THE DRAWINGS

The present invention can be more fully understood by reading the following detailed description of the preferred embodiments, with reference made to the accompanying drawings, wherein:

FIG. 1 is a systemic block diagram showing architecture of a warehouse management system according to the present invention applied to suppliers and retailers;

FIG. 2 is a systemic block diagram showing detailed architecture of the warehouse management system according to the present invention applied to suppliers and retailers;

FIG. 3 is a schematic diagram showing an example of a supplier management interface provided by the warehouse management system in the present invention corresponding to a supplier;

FIG. 4 is a schematic diagram showing an example of a retailer management interface provided by the warehouse management system in the present invention corresponding to a retailer; and

FIGS. 5(A), 5(B) and 5(C) are block diagrams showing various embodiments of the warehouse management system according to the present invention.

### DETAILED DESCRIPTION OF THE PREFFERED EMBODIMENTS

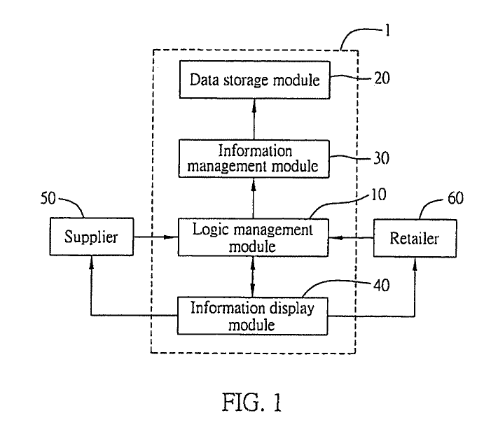

FIGS. 1, 2, 3, 4, 5(A), 5(B) and 5(C) illustrate a warehouse management system 1 proposed in the present invention. These drawings are used in conjunction with the following detailed description to recite preferred embodiments of the warehouse management system in the present invention. It is to be noted that the drawings are simplified schematic diagrams only showing the basic structure of the present invention. Thus, the drawings only provide architecture relating to the present invention, and configuration of the warehouse management system may be more complex in actual implementation.

The warehouse management system I in the present invention is applied in data processing devices under a network environment The data processing devices can be desktop computers, notebook computers, servers, or workstations, etc. The warehouse management system 1 is used to integrate warehouses of suppliers and retailers under the network environment and establish an information communication channel between suppliers and retailers. FIG. 1 is a schematic diagram showing architecture of the warehouse management system 1 in the present invention applied to suppliers and retailers. As shown in FIG. 1, the warehouse management system 1 includes a logic management module 10 for allowing at least one supplier 50 and at least one retailer 60 to enter information; a data storage module 20 for storing the information; an information management module 30 for synchronously updating the information to the data storage module 20; and an information display module 40 for synchronously displaying the information on the data processing devices (not shown).

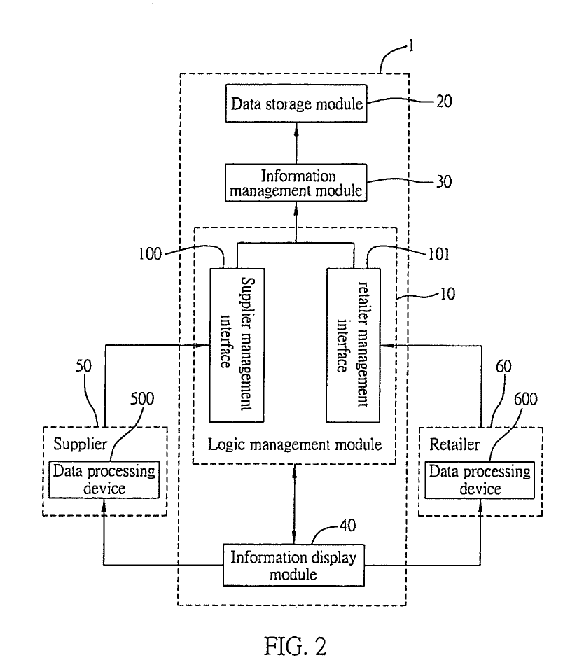

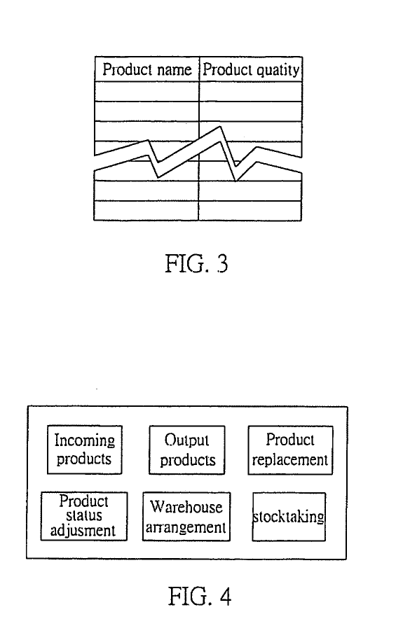

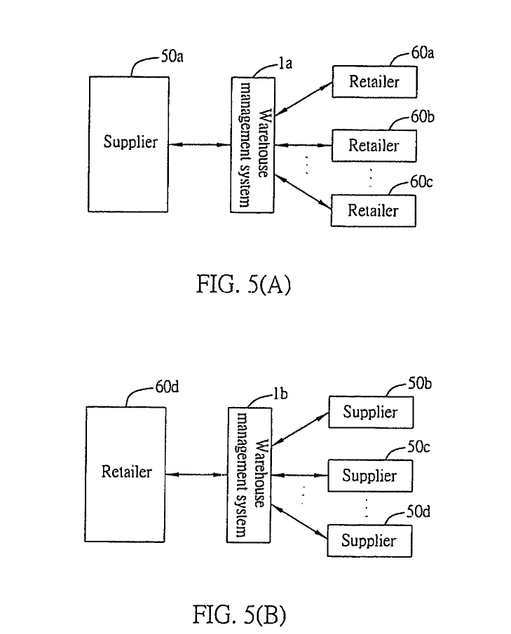

The logic management module 10, as shown in FIG. 2, includes a supplier management interface 100 corresponding to the supplier 50, and a retailer management interface 101 corresponding to the retailer 60. The supplier management interface 100 is for allowing the supplier 50 to enter information, and the retailer management interface 101 is for allowing the retailer 60 to enter information. That is, the supplier 50 and the retailer 60 can enter information respectively through the supplier management interface 100 and the retailer management interface 101 provided by the logic management module 10. As shown in FIG. 3 of an example of a supplier management interface, this supplier management interface allows the supplier to enter information of names and quantities of products being supplied by the supplier, that is, the supplier can enter names and quantities of all products being supplied and to be sold to retailers, such as products manufactured by this supplier or by other suppliers, through the supplier management interface. Moreover, as shown in FIG. 4 of an example of a retailer management interface, this retailer management interface allows the retailer to enter information such as incoming products, output products, product replacement, product status adjustment, warehouse arrangement and stocktaking, that is, the retailer can enter information through the retailer management interface according to the status of products and warehouses.

The foregoing information of incoming products refer to quantities of incoming products, i.e. the quantities of products the retailer purchases from the supplier, such that correspondingly the quantities of such products would be decreased in the supplier, and stock quantities of these products in a warehouse of the retailer are increased. The foregoing information of output products refers to quantities of sold products, i.e. the quantities of products sold by the retailer, such that correspondingly stock quantities of these products in the retailer's warehouse would be decreased. The foregoing information of product replacement refers to quantities of replaced products, i.e. the quantities of replaced products that are sold from the retailer to clients, and every time of replacement would correspondingly increase and decrease stock quantities of these products in the retailer's warehouse. The foregoing information of product status adjustment refers to a status of products, which is the status of products in the retailer's warehouse, wherein such status can be specified according to a user's requirement, including e.g. normal, inferior, damaged and other items. The foregoing information of warehouse arrangement refers to a usage status of warehouses of the retailer, that is, if a retailer owns a plurality of warehouses, a part of products can be relocated from one warehouse to another. The foregoing information of stocktaking refers to actual stock quantities of products of the retailer, that is, the stock quantities of a part of or all products in the warehouse are checked to replace the stock quantities in the system with the actual stock quantities of products.

The data storage module 20, as shown in FIG. 2, is an information storage database used to store the information entered by the supplier 50 and the retailer 60 through the supplier management interface 100 and the retailer management interface 101 respectively.

The information management module 30, as shown in FIG. 2, is used to synchronously update the information, which is entered by the supplier 50 and the retailer 60 through the supplier management interface 100 and the retailer management interface 101 respectively, to the data storage module 20. That is, the information entered by the supplier 50 and the retailer 60 through the supplier management interface 100 and the retailer management interface 101 respectively would synchronously update information stored in the data storage module 20. For example, the supplier 50 adds a new product to be sold to the retailer 60, and enters information of the name and quantity of this product through the supplier management interface 100, such that the information management module 30 would synchronously update the entered information to the data storage module 20, and thus the name and quantity of the product are added to the data storage module 20.

The information display module 40 is used to display the supplier management interface 100 and the retailer management interface 101 on the data processing devices 500, 600 respectively, and synchronously display the information, which is entered by the supplier 50 and the retailer 60 through the supplier management interface 100 and the retailer management interface 101 respectively, on the data processing devices 500, 600. In other words, the information display module 40 displays the supplier management interface 100 and the retailer management interface 101 on the data processing devices 500, 600 of the supplier 50 and retailer 60 respectively, such that the supplier 50 and the retailer 60 can use the supplier management interface 100 and the retailer management interface 101 that are displayed on screens of the data processing devices 500, 600 to enter information respectively; and this information is synchronously displayed by the information display module 40 on the screens of the data processing devices 500, 600 of the supplier 50 and retailer 60 respectively, such that the supplier 50 and the retailer 60 can read the information shown on the screens of the data processing devices 500, 600. The information shown on the screen of the data processing device 500 at the supplier 50 includes product related information of the supplier 50, which can be specified according to the user's requirement, such as product names, product quantities, and stock quantities of products in a retailer's warehouse, etc. The information shown on the screen of the data processing device 600 at the retailer 60 includes product and warehouse related information of the retailer 60, which can be specified according to the user's requirement, such as incoming products, output products, product replacement, product status adjustment, warehouse arrangement, stocktaking and so on for the retailer 60.

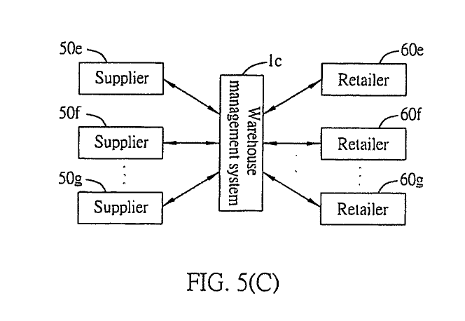

FIGS. 5(A), 5(B) and 5(C) are used to further clarify the application scope of the warehouse management system in the present invention. As shown in FIG. 5(A), a supplier 50a provides products to a plurality of retailers 60a, 60b, 60c through the warehouse management system 1a in the present invention. As shown in FIG. 5(B), a retailer 60d purchases products from a plurality of suppliers 50b, 50c, 50d through the warehouse management system 1b in the present invention. As shown in FIG. 5(C), a plurality of suppliers 50e, 50f, 50g provide products to a plurality of retailers 60e, 60f, 60g at the same time through the warehouse management system 1c l in the present invention. From these embodiments shown in FIGS. 5(A), 5(B) and 5(C), it is realized that the warehouse management system in the present invention has a wide application range, which not only increases commercial opportunities but also enhances economic benefits

By the foregoing description and drawings, it is clearly understood that the warehouse management system in the present invention utilizes the logic management module for allowing suppliers and retailers to enter information, and also utilizes the information display module to synchronously display the information at the suppliers and retailers, such that integration of warehouse management can be achieved, and management efficiency and economic benefits are enhanced.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A warehouse management system applied in data processing devices under a network environment, for integrating warehouses of suppliers and retailers under the network environment to provide an information communication channel between the suppliers and retailers, the warehouse management system comprising:
a logic management module comprising a supplier management interface corresponding to at least one supplier, and a retailer management interface corresponding to at least one retailer, wherein the supplier management interface allows the supplier to enter information, and the retailer management interface allows the retailer to enter information; and
an information display module for displaying the supplier management interface and the retailer management interface on the data processing devices respectively, and synchronously displaying the information, which is entered by the supplier and the retailer through the supplier management interface and the retailer management interface respectively, on the data processing devices.

2. The warehouse management system of claim 1, further comprising:
a data storage module for storing the information entered by the supplier and the retailer through the supplier management interface and the retailer management interface respectively; and
an information management module for synchronously updating the information, which is entered by the supplier and the retailer through the supplier management interface and the retailer management interface respectively, to the data storage module.

3. The warehouse management system of claim 1, wherein the supplier management interface allows the supplier to enter the information of names and quantities of products being supplied by the supplier.

4. The warehouse management system of claim 1, wherein the retailer management interface allows the retailer to enter the information including at least one of incoming products, output products, product replacement, product status adjustment, warehouse arrangement and stocktaking.

5. The warehouse management system of claim 4, wherein the information of incoming products refers to quantities of the products being purchased by the retailer from the supplier.

6. The warehouse management system of claim 4, wherein the information of output products refers to quantities of the products being sold by the retailer.

7. The warehouse management system of claim 4, wherein the information of product replacement refers to quantities of replaced products being sold by the retailer.

8. The warehouse management system of claim 4, wherein the information of product status adjustment refers to a status of products in a warehouse of the retailer.

9. The warehouse management system of claim 4, wherein the information of warehouse arrangement refers to a usage status of warehouses of the retailer.

10. The warehouse management system of claim 4, wherein the information of stocktaking refers to actual stock quantities of products of the retailer.

11. The warehouse management system of claim 1, wherein the information display module displays product related information of the supplier on the data processing device at the supplier.

12. The warehouse management system of claim 11, wherein the product related information of the supplier includes at least one of names, quantities, and stock quantities in a retailer's warehouse of products being supplied by the supplier.

13. The warehouse management system of claim 1, wherein the information display module displays product and warehouse related information of the retailer on the data processing device at the retailer.

14. The warehouse management system of claim 13, wherein the product and warehouse related information of the retailer includes at least one of incoming products, output products, product replacement, product status adjustment, warehouse arrangement and stocktaking.

15. The warehouse management system of claim 14, wherein the information of incoming products refers to quantities of the products being purchased by the retailer from the supplier.

16. The warehouse management system of claim 14, wherein the information of output products refers to quantities of the products being sold by the retailer.

17. The warehouse management system of claim 14, wherein the information of product replacement refers to quantities of replaced products being sold by the retailer.

18. The warehouse management system of claim 14, wherein the information of product status adjustment refers to a status of products in a warehouse of the retailer.

19. The warehouse management system of claim 14, wherein the information of warehouse arrangement refers to a usage status of warehouses of the retailer.

20. The warehouse management system of claim 14, wherein the information of stocktaking refers to actual stock quantities of products of the retailer.
